(19) United States
(12) Patent Application Publication
(10) Pub. No.: US 2011/0076206 A1
(43) Pub. Date: Mar. 31, 2011

(54) Reagent containers for compact test devices

(76) Inventors: Yue Yao, Issaquah, WA (US); Zhihao Lin, Princeton Junction, NJ (US); Yaqi Li, New Hope, PA (US)

(21) Appl. No.: 12/924,488

(22) Filed: Sep. 28, 2010

Related U.S. Application Data
(60) Provisional application No. 61/277,725, filed on Sep. 29, 2009.

(51) Int. Cl. B01L 3/00

(52) U.S. Cl. 422/554

(57) ABSTRACT

Embodiments disclosed herein relate to reagent containers configured to allow for different liquid and solid reagents to be mixed in situ prior to the measurement.

### CROSS REFERENCE TO RELATED APPLICATIONS

This application claims priority to U.S. Provisional Patent Application Number 61/277,725, filed on Sept. 29, 2009, the entirety of which is hereby incorporated by reference.

### BACKGROUND

1. Field of the Invention

This disclosure relates generally to reagent container design. More specifically, embodiments disclosed herein relate to a new class of reagent containers configured to allow for different liquid and solid reagent samples to be mixed in situ prior to the measurement.

2. Background

Liquid test reagents have many advantages over the solid test strips. For example, the manufacture process is typically simpler, cost of material is often less expensive; detection sensitivity and accuracy are typically higher, etc. However, there can be substantial difficulty in using liquid reagents in everyday life by a layperson. The difficulty typically lies in how to measure a small amount of liquid accurately, and how to mix different liquids in a prescribed manner that avoids contamination and protects the operator from accidental exposure to liquid chemicals.

A need therefore exists to overcome the aforementioned shortcomings in the art.

### BRIEF DESCRIPTION OF THE DRAWINGS

FIGS. 1A-1E illustrate a first embodiment of a reagent container;

FIG. 2 illustrates a second embodiment of a reagent container;

FIGS. 3A-3B illustrate a third embodiment of a reagent container; and

FIGS. 4A-4D illustrate a fourth embodiment of a reagent container.

### DETAILED DESCRIPTION

Embodiments disclosed herein provide a new class of reagent containers configured to allow for different liquid and solid reagent samples to be mixed in situ prior to the measurement (e.g., by a compact test device). In one embodiment, for example, a reagent container may contain premeasured liquid (and solid) reagents for a particular test and store different liquid (and solid) reagent samples in separate compartments until usage. The mixing of different samples may be carried out sequentially in accordance with a particular test procedure (e.g., depending upon the underlying reaction process, etc.). For example, two or more liquid samples may be mixed first, and then combined with the rest of the samples. In another example, a reagent container may be configured to allow a liquid reagent and a gas to be mixed first, followed by a measurement on the liquid-gas mixture, or combining the liquid-gas mixture with another reagent (prior to a measurement).

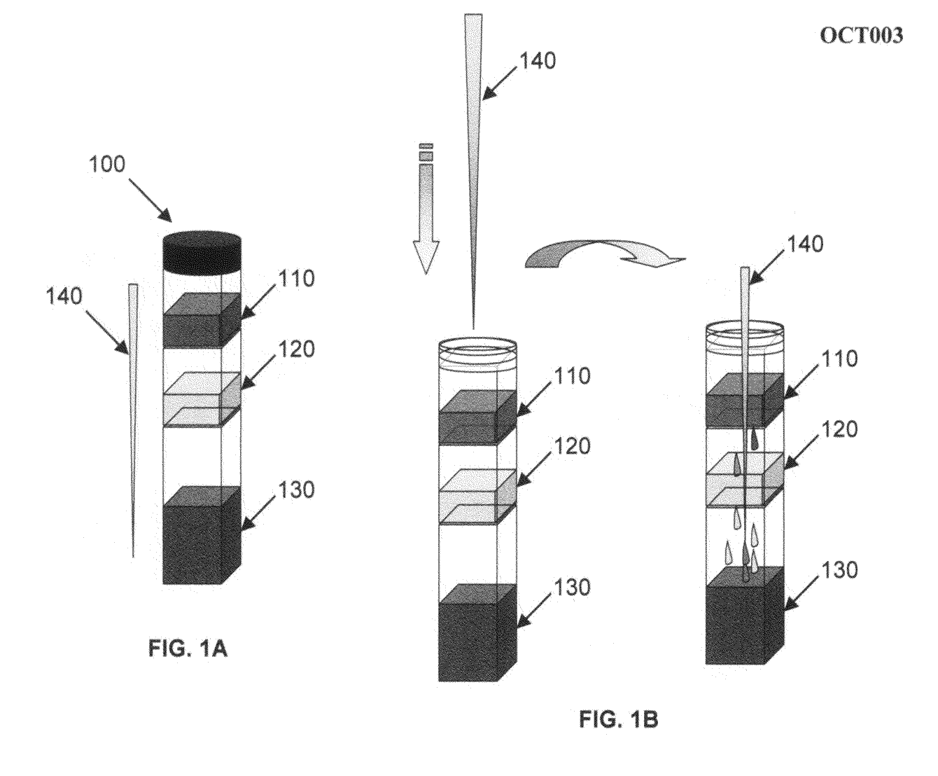

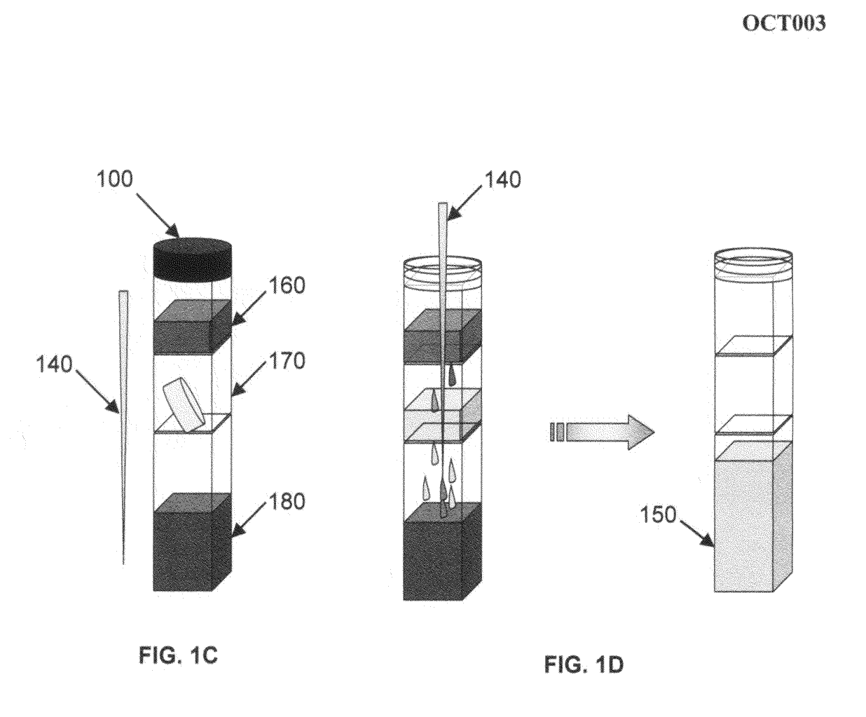

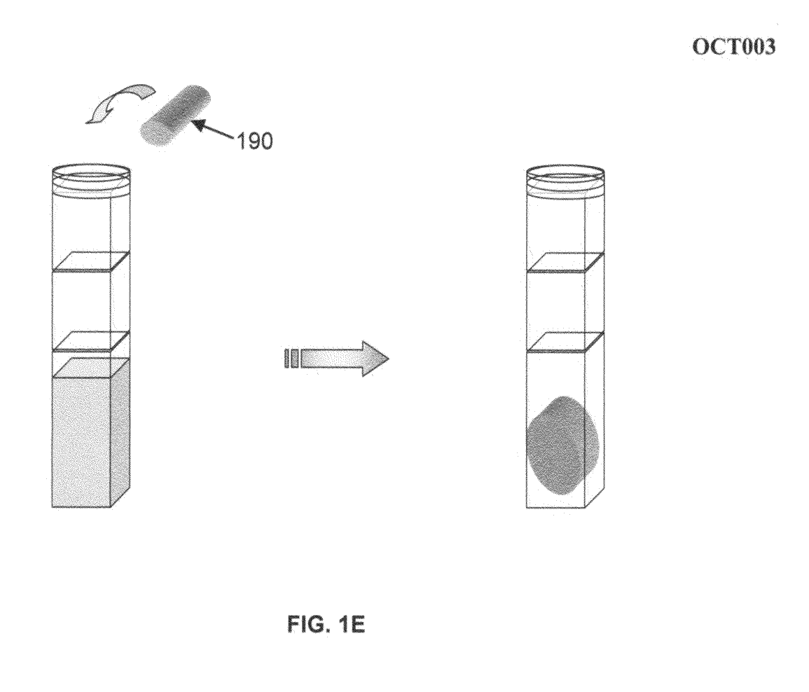

FIGS. 1A-1E illustrate a first embodiment of a reagent container 100. By way of example, three different solutions (e.g., liquid reagents) are stored in three separate compartments (or modules) 110, 120, 130. The bottom and top of each compartment may be sealed by a plastic film or a thin piece of glass. The compartments may be connected to each other by a “clip” or a “screw-on”. The test site may be anywhere in the container (e.g., the bottom, middle, or upper compartment). In addition, a mixing means 140 (e.g., a sharp object such as a pipette tip) may also be provided along with the container 100 (e.g., the container and the mixing means may be packaged as a test kit), serving to piecing through two or more compartments to cause the constituent liquids to mix, as further illustrated in FIG. 1B.

In one example as shown in FIG. 1B, the pipette 140 may be used to draw a test sample (e.g., a body fluid such as urine, or other test analyte) first, followed by piercing it through the separations for different compartments, thereby dispending the test sample analyte into the bottom compartment. FIG. 1D shows a situation where all the solutions and the analyte are mixed together, whereby the mixed solution 150 is ready for a measurement (e.g., by a compact, or handheld, test device). In general, the mixing means 140 may be any object configured to cause reagent samples in different compartments to mix. The mixing means may 140 further be capable of carrying another (or external) test sample (e.g., a body fluid or other test analyte) and cause the external test sample to be mixed with the reagents inside the container, such as described above.

Further, the reagents do not have to be liquids only. As illustrated in FIG. 1C, two different liquid reagents 160, 170 and one solid reagent 180 may be stored in three separate compartments initially. The operation procedures for this set-up may nonetheless be similar to those for all liquid samples (such as described above). For example, the separation between the top and middle compartments may be pieced through (e.g., by use of a pipette such as described above), so that the solid reagent is dissolved by the liquid reagent from the top compartment. A measurement may be performed on this liquid-solid mixture in the middle compartment first (if so desired), before the mixture is subsequently combined with the liquid reagent in the bottom compartment.

In some applications, it may be desired to neutralize and absorb the sample mixture after the measurement (e.g., to avoid chemical contamination or spill, etc.). For example, a solid substance 190, such as a tablet, a “cotton ball”, a gelatin droplet or anything that is capable of absorbing and neutralizing the liquid, may be inserted into the container to absorb the remaining sample mixture, such as illustrated in FIG. 1E.

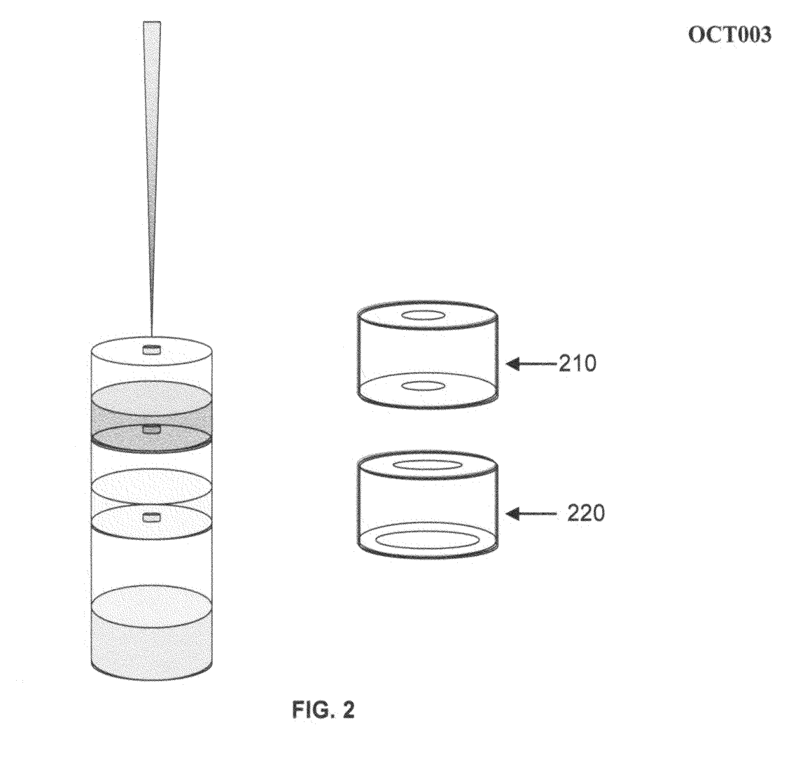

In the above examples, for illustration, each compartment (or module) is shown to be rectangular in cross-section. In general, it may be of any shape (e.g., round, square, polygonal, etc.), or size. Further, a compartment may be sealed with an object such as a stopper, a thin film, or other means configured to seal the liquid sample enclosed therein (termed “sealing means”). The opening in the sealing means may also be of any shape or size (which may be equal or smaller than the top or bottom cross-sectional area), depending upon the need of an application, such as illustrated by elements 210, 220 in FIG. 2.

Further, separate reagent containers (e.g., each having a plurality of sample compartments such as described above) may be assembled together in a screw-on type configuration, a clip-on type configuration, or by other means.

In some applications, a series of measurements may be carried out as different liquid (or solid) samples are mixed sequentially, or in accordance with a prescribed order (e.g., depending upon the underlying reaction process devised for a particular test). Further, a set of measurements may be performed with respect to a first container (e.g., having a plurality of sample compartments), such as described above, which is then followed by connecting the first container to a second one and performing additional measurements (such as described above).

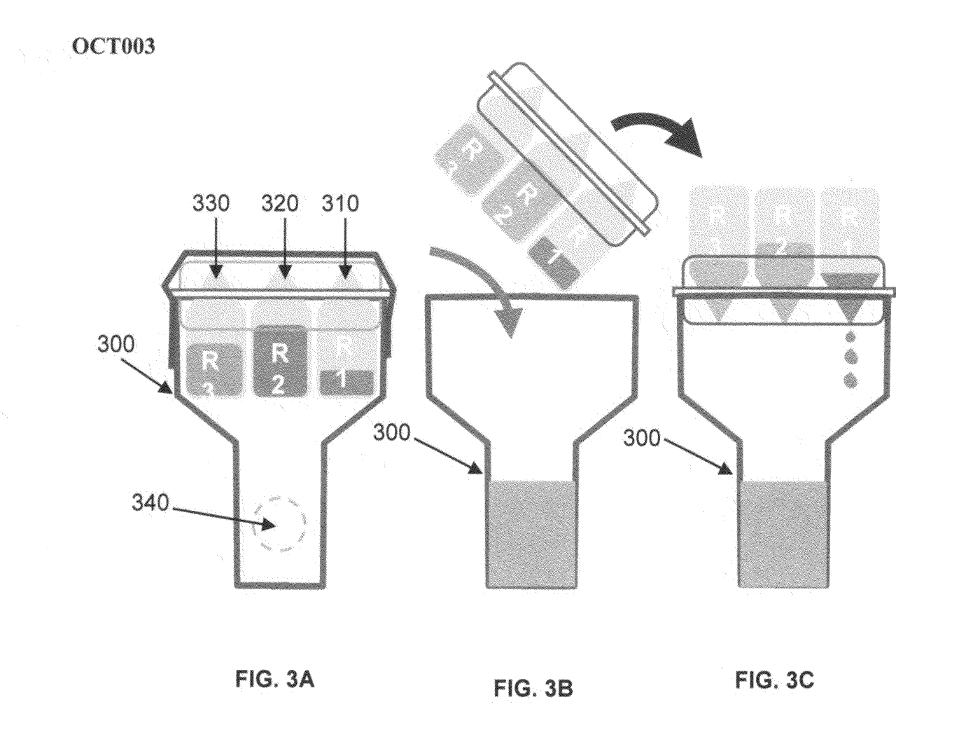

FIGS. 3A-3C illustrate another embodiment of a reagent container 300. As shown in FIG. 3A, the container 300 may include a plurality of (e.g., three) sample holders or modules 310, 320, 330, containing three different liquid reagent samples (e.g., reagents R1, R2, R3), respectively. By way of example, the modules are shown to be each shaped like a bottle, and disposed side-by-side above a measuring section/area inside the container. The modules may also be of other shape and size, and/or in other arrangements (e.g., stacked, etc.) suitable for a given application. The container 300 is also shown to include a measurement area 340.

When ready to make a measurement, the modules (or bottles) 310, 320, 330 may be flipped over, such as illustrated in FIGS. 3B and 3C. The seal in each bottle may subsequently be broken (e.g., by way of squeezing) to allow the constituent liquid reagent to drip into the measuring area 340, such as illustrated in FIG. 3C. In some situations, the bottles may be broken in a sequence (e.g., one by one), so as to allow a series of measurements to be performed on different sample mixtures.

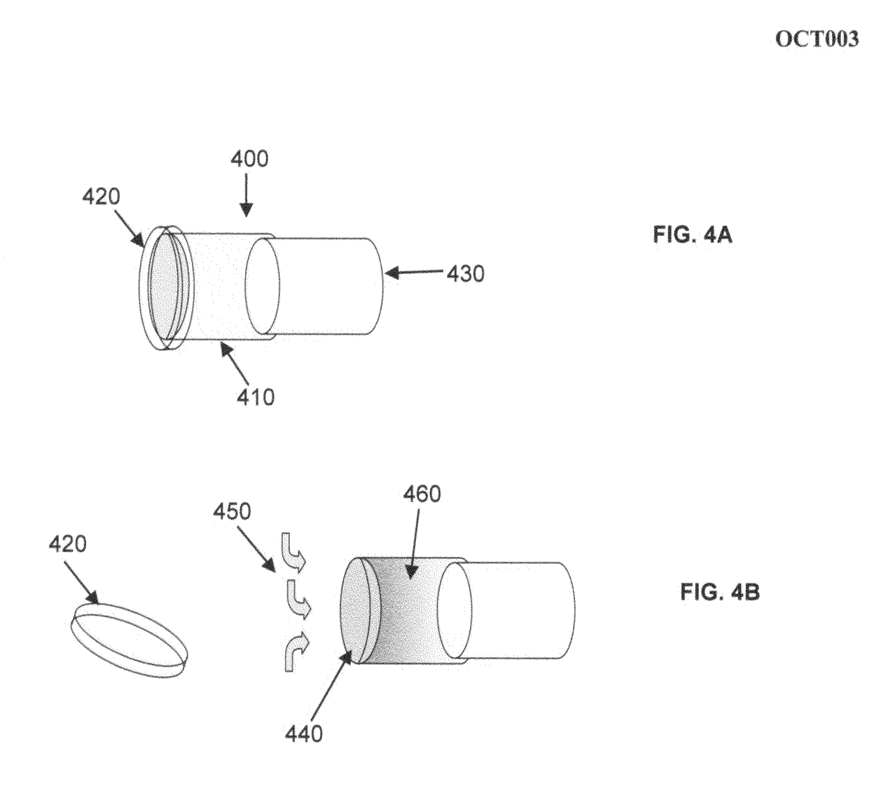

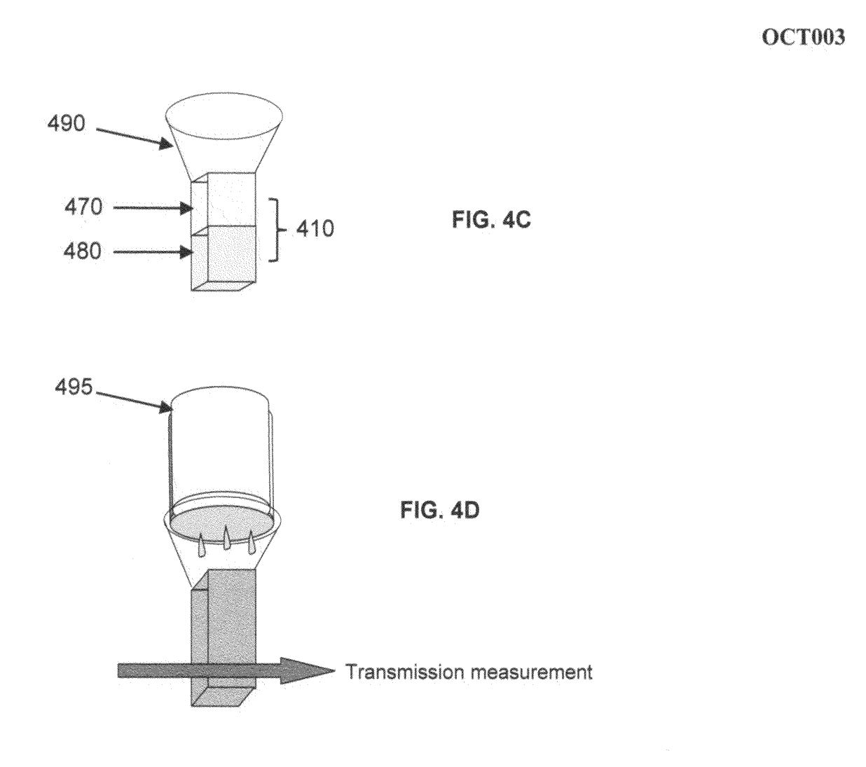

In some applications, the measurement sample may be a mixture of liquid and gas. FIGS. 4A-4C illustrate an embodiment of a reagent container 400 configured for such applications. As illustrated in FIG. 4A, the container 400 may include a “receiving solution” portion (or module) 410, a cap 420 configured to be coupled to the receiving solution module 410, and a plunger 430 configured to fit snuggly inside and slide along the receiving solution module 410. A porous filter 440 may also be disposed between the cap 420 and the coupling end of the receiving solution module 410, as further illustrated in FIG. 4B.

In one example, the cap 420 may be first removed to allow air pollutants 450 to diffuse through the porous filter 440 and be captured by the receiving solution (e.g., a liquid reagent) 460, such as illustrated in FIG. 4B. In another example, the container may be disposed in a gaseous environment containing a particular gas to be mixed with the receiving solution. In any case, the gas may flow into the receiving solution naturally, or be forced. Alternatively, the receiving solution module may contain a gas first, and the plunger is then engaged to allow a liquid sample to be sucked into the module and consequently mix with the existing gas.

In some applications, the receiving solution module 410 may further contain two (or more) different liquid samples 470, 480 (e.g., separated by a membrane), such as illustrated in FIG. 4C. Prior to making a measurement, one liquid sample may first be mixed with a gas (such as illustrated in FIG. 4B). A coupling means 490 (e.g., a funnel-like device) may then be used to couple the sample container to a measurement device 490, such as illustrated in FIGS. 4C and 4D. The plunger may further be engaged to cause the different liquid samples to be mixed and also to discharge the mixed solution to the measuring area for measurement, such as shown in FIG. 4D. (Note, the plunger may serve as a mixing means in the example of FIGS. 4A-4D.)

Embodiments disclosed herein provide some examples of reagent containers configured to allow for different liquid and solid reagents to be mixed in situ prior to the measurement. There are other examples and embodiments.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

WHAT IS CLAIMED IS:

1. An apparatus, comprising:
a plurality of compartments containing reagents; and
a mixing means configured to cause the reagents to be mixed.

2. The apparatus of claim 1, wherein the reagents include liquid reagents.

3. The apparatus of claim 1, wherein the reagents include at least one liquid reagent and at least one solid reagent.

4. The apparatus of claim 1, wherein the reagents include at least one liquid reagent and at least one gas reagent.

5. The apparatus of claim 1, wherein the mixing means is further configured to cause the reagents to be mixed with an additional test sample.

6. The apparatus of claim 4, wherein the additional test sample includes a body fluid.

7. The apparatus of claim 4, wherein the additional test sample include a gas.

8. The apparatus of claim 1, wherein the mixing means includes a pipette.

9. The apparatus of claim I, wherein the mixing means includes a plunger.

10. The apparatus of claim 1, wherein the apparatus is further configured to be coupled to a test device.
